(19) United States
(12) Patent Application Publication
(10) Pub. No.: US 2026/0112740 A1
(43) Pub. Date: Apr. 23, 2026

(54) BATTERY PACK

(71) Applicant: MURATA MANUFACTURING CO., LTD., Kyoto (JP)

(72) Inventor: Yoshiyuki BANNAI, Kyoto (JP)

(21) Appl. No.: 19/423,157

(22) Filed: Dec. 17, 2025

Related U.S. Application Data
(63) Continuation of application No. PCT/JP2024/018727, filed on May 21, 2024.

(30) Foreign Application Priority Data
Aug. 2, 2023 (JP) 2023-126273

(51) Int. Cl. H01M 10/659; H01M 10/643; H01M 50/213; H01M 50/291

(52) U.S. Cl. CPC H01M 10/659; H01M 10/643; H01M 50/213; H01M 50/291

(57) ABSTRACT

A battery pack includes a cylindrical secondary battery and a heat absorbing member, and an exterior body of the heat absorbing member accommodates a heat absorbing agent between a first inner resin layer L1a and a second inner resin layer. A flange portion of the exterior body has an inner resin continuous portion in which the first inner resin layer and the second inner resin layer are continuous over the entire circumference. In a sectional shape of the heat absorbing member, the inner resin continuous portion includes a first continuous portion located inward of a first metal layer and a second metal layer, and a second continuous portion, a third continuous portion, and a fourth continuous portion each having a portion exposed to outside of the exterior body. The heat absorbing member is arranged in an orientation in which the first continuous portion is closer to an end of the secondary battery than the second continuous portion, the third continuous portion, and the fourth continuous portion in an axial direction of the secondary battery.

### CROSS REFERENCE TO RELATED APPLICATIONS

The present application is a continuation of International Application No. PCT/JP2024/018727, filed on May 21, 2024, which claims priority to Japanese Patent Application No. 2023-126273, filed on August 2, 2023, the entire contents of which are incorporated herein by reference.

### BACKGROUND

The present disclosure relates to a battery pack.

An example is disclosed of a battery pack, a battery module including a heat absorbing member and a plurality of battery cells. The heat absorbing member includes a heat absorbing agent and an exterior film enclosing the heat absorbing agent. At the time of abnormal heat generation of a secondary battery, an exterior film is cleaved, and the temperature of the secondary battery is lowered by the leaked heat absorbing agent.

### SUMMARY

The present disclosure relates to a battery pack.

However, in a case where the portion where the exterior film is cleaved is relatively close to the end of the secondary battery, the heat absorbing agent flowing out of the exterior film may remain near the end of the secondary battery. In this case, a contact area between an outer surface of the secondary battery and the heat absorbing agent is relatively small, and heat absorption efficiency is relatively low.

The present disclosure, in an embodiment, relates to improve heat absorption efficiency of a heat absorbing agent at the time of abnormal heat generation of a secondary battery in a battery pack.

A battery pack of the present disclosure, in an embodiment, includes: a plurality of secondary batteries each having a cylindrical shape; and a heat absorbing member that has a heat absorbing agent and an exterior body accommodating the heat absorbing agent, the exterior body includes a first exterior portion that has a first resin layer and a first metal layer overlapping with the first resin layer, and a second exterior portion that has a second resin layer facing the first resin layer and a second metal layer overlapping with the second resin layer, the exterior body integrally includes an accommodating portion that accommodates the heat absorbing agent between the first resin layer and the second resin layer, and a flange portion in which the first resin layer and the second resin layer overlap with each other over an entire circumference of the accommodating portion, the flange portion has a continuous portion in which the first resin layer and the second resin layer are continuous over an entire circumference around the accommodating portion, the continuous portion includes a first portion and a second portion, the first portion is located inward of at least one of the first metal layer or the second metal layer in a sectional shape of the heat absorbing member when cut along a plane along a thickness direction of the flange portion, the second portion has a portion exposed to outside of the exterior body in the sectional shape of the heat absorbing member when cut along the plane along the thickness direction of the flange portion, and the heat absorbing member is arranged in an orientation in which the first portion is closer to an end of each of the secondary batteries than the second portion in an axial direction in which a center axis of each of the secondary batteries extends.

According to the present disclosure, in an embodiment, it is possible to improve the heat absorption efficiency of the heat absorbing agent at the time of abnormal heat generation of the secondary battery in the battery pack.

### BRIEF DESCRIPTION OF THE FIGURES

FIG. 1 is an exploded perspective view of a battery pack according to an embodiment of the present disclosure.

FIG. 2 is an exploded perspective view of a battery unit illustrated in FIG. 1.

FIG. 3 is a longitudinal sectional view of a secondary battery illustrated in FIG. 2.

FIG. 4 is a plan view of a heat absorbing member.

FIG. 5 is a view illustrating a sectional shape of the heat absorbing member taken along line V-V illustrated in FIG. 4.

FIG. 6 is a view illustrating a sectional shape of the heat absorbing member taken along line VI-VI illustrated in FIG. 4.

FIG. 7 is a perspective view illustrating an exterior body before accommodating a heat absorbing agent.

FIG. 8 is a view illustrating arrangement of the heat absorbing member when viewed along a direction orthogonal to an axial direction in which a center axis of a secondary battery extends.

FIG. 9 is a perspective view of a heat absorbing member of a battery pack according to an embodiment of the present disclosure.

FIG. 10 is a partial sectional view of a battery unit according to an embodiment.

FIG. 11 is a perspective view of one set of heat absorbing members included in a battery pack according to an embodiment of the present disclosure.

FIG. 12 is a plan view of one set of heat absorbing members illustrated in FIG. 11.

FIG. 13 is a view mainly illustrating a sectional shape of a coupling portion in a sectional shape of one set of heat absorbing members when cut along a plane along a thickness direction of a flange portion of the heat absorbing member.

FIG. 14 is a perspective view illustrating an exterior body of one set of heat absorbing members before accommodating the heat absorbing agent.

### DETAILED DESCRIPTION

The present application will be described in further detail including with reference to the drawings according to an embodiment. Note that the present disclosure is not limited by the embodiments. Each of the embodiments is illustrative, where parts of the configurations illustrated in the different embodiments can be replaced or combined with each other.

An X direction in the drawings corresponds to a width direction of a battery pack 1, a Y direction corresponds to a depth direction of the battery pack 1, and a Z direction corresponds to a height direction of the battery pack 1. The X direction, the Y direction, and the Z direction are orthogonal to each other. In the X direction, a side indicated by an arrow is defined as a +X side, and a side opposite to the +X side is defined as a -X side. In the Y direction, a side indicated by an arrow is defined as a +Y side, and a side opposite to the +Y side is defined as a -Y side. In the Z direction, a side indicated by an arrow is defined as a +Z side, and a side opposite to the +Z side is defined as a -Z side. Note that the X, Y, and Z directions are examples, and the present disclosure is not limited to these directions.

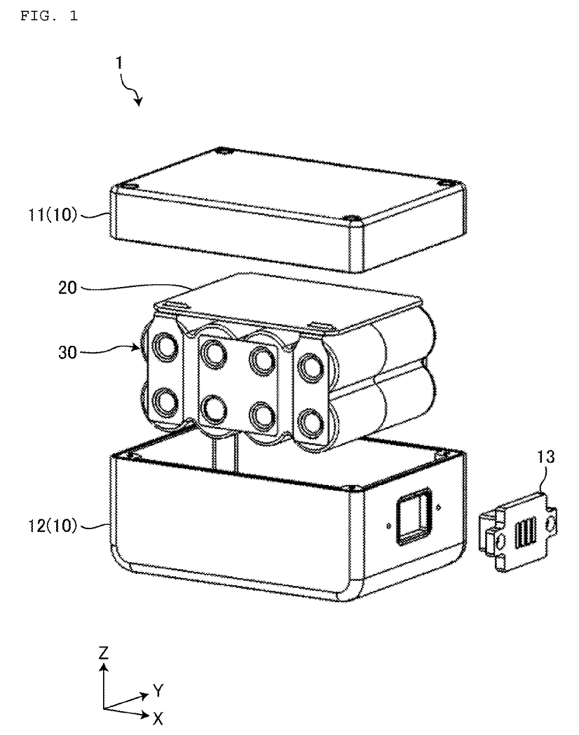

FIG. 1 is an exploded perspective view of the battery pack 1 according to a first embodiment of the present disclosure. The battery pack 1 can be applied as a power source to an external device (not illustrated) such as an electronic device, an electric vehicle, and an electric tool. The battery pack 1 includes an exterior case 10, a control board 20, and a battery unit 30.

The exterior case 10 has a box shape and accommodates the control board 20 and the battery unit 30. The exterior case 10 includes a first case portion 11 and a second case portion 12.

In addition, a connector 13 is attached to the exterior case 10. The connector 13 electrically connects an external device and the battery unit 30 via the control board 20, and supplies (discharges) power of the battery unit 30 to the external device. Further, the connector 13 electrically connects a power supply (for example, a commercial power supply) and the battery unit 30 via the control board 20, and supplies (charges) power from the power supply to the battery unit 30. The control board 20 controls charging and discharging of the battery unit 30.

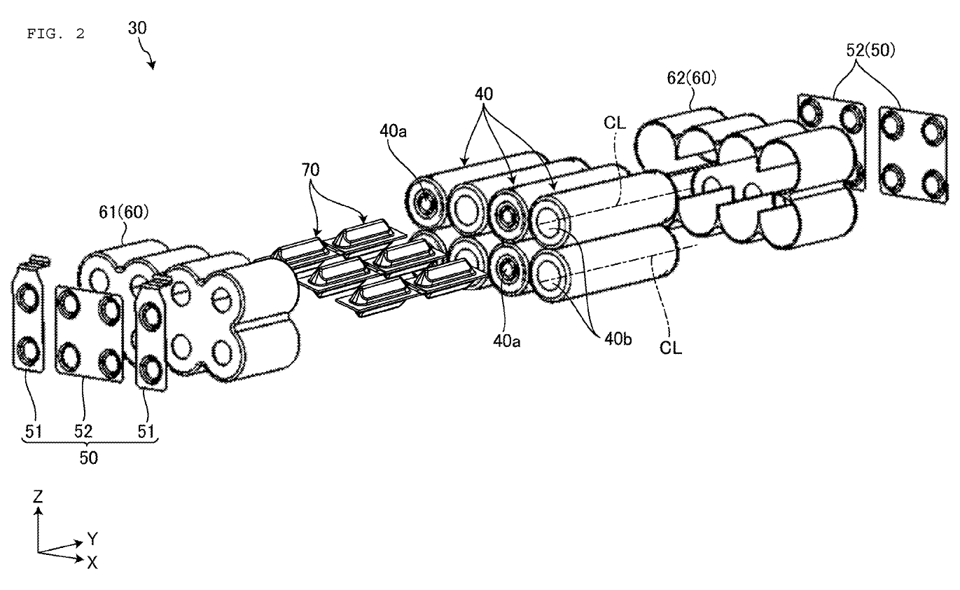

FIG. 2 is an exploded perspective view of the battery unit 30 illustrated in FIG. 1. The battery unit 30 includes a plurality of secondary batteries 40, a plurality of lead plates 50, a holder 60, and a plurality of heat absorbing members 70.

The secondary battery 40 is, for example, a lithium ion battery. The secondary battery 40 has a cylindrical shape. The secondary battery 40 has a positive electrode terminal 40a and a negative electrode terminal 40b as electrodes at both ends. In the first embodiment, the number of the secondary batteries 40 is eight. It goes without saying that the number of secondary batteries 40 is not limited to eight.

The plurality of secondary batteries 40 are arranged in parallel in a state of spacing apart from each other. Center axes CL of the plurality of secondary batteries 40 are parallel to each other. In the first embodiment, the center axis CL of the secondary battery 40 is along the Y direction. In addition, in the plurality of the secondary batteries 40, an orientation of the positive electrode terminal 40a and an orientation of the negative electrode terminal 40b are arranged in a predetermined orientation.

The plurality of secondary batteries 40 are arranged in two rows. Specifically, four secondary batteries 40 are arranged along the X direction, and two secondary batteries 40 are arranged along the Y direction. It goes without saying that the arrangement of the plurality of secondary batteries 40 is not limited to two rows.

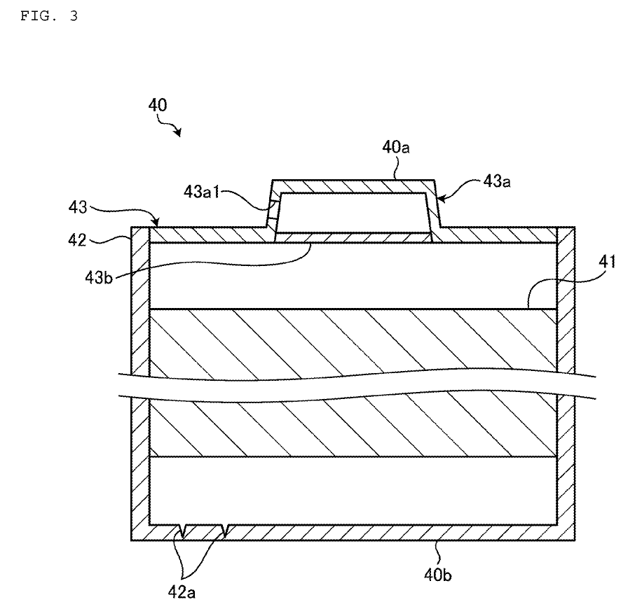

FIG. 3 is a longitudinal sectional view of the secondary battery 40 illustrated in FIG. 2. The secondary battery 40 includes an electrode assembly 41, a can 42, and a lid 43. The can 42 and the lid 43 are made from, for example, iron, stainless steel, or aluminum, and have conductivity.

The electrode assembly 41 is formed by laminating and winding a plurality of sheet-like positive electrodes (not illustrated) and a plurality of sheet-like negative electrodes (not illustrated) with a separator (not illustrated) interposed therebetween.

The can 42 has a tubular shape having an opening on one end side. The can 42 is electrically connected to the negative electrode of the electrode assembly 41 via a current collecting foil (not illustrated). A central portion of an end surface on the other end side of the can 42 is the negative electrode terminal 40b of the secondary battery 40.

The lid 43 has a plate shape and covers the opening on one end side of the can 42. The lid 43 and the can 42 are electrically insulated by an insulating member (not illustrated). The lid 43 is electrically connected to the positive electrode of the electrode assembly 41 via the current collecting foil.

The lid 43 has a protruding portion 43a and a cleavage valve 43b. The protruding portion 43a is located at a central portion of the lid 43. A protruding end surface of the protruding portion 43a is the positive electrode terminal 40a of the secondary battery 40. In addition, a hole 43a1 that allows the inside and the outside of the secondary battery 40 to communicate with each other is provided in the protruding portion 43a. Note that a plurality of the holes 43a1 may be provided.

The cleavage valve 43b is located inward of the protruding portion 43a inside the secondary battery 40. The cleavage valve 43b defines a space communicating with the hole 43a1 inside the secondary battery 40 and a space in which the electrode assembly 41 is located. When an internal pressure of the secondary battery 40 becomes a predetermined value or more, the cleavage valve 43b is cleaved to be in an open state.

In addition, a battery thin-walled portion 42a is provided on the other end side of the can 42. The battery thin-walled portion 42a is a portion having a small thickness on the other end side of the can 42. The other end side of the can 42 is cleaved from the battery thin-walled portion 42a when the internal pressure of the secondary battery 40 becomes high. For example, in a case where the cleavage valve 43b is not in an open state even when the internal pressure of the secondary battery 40 becomes a predetermined value or more, when the internal pressure of the secondary battery 40 further increases, the other end side of the can 42 is cleaved from the battery thin-walled portion 42a.

The lead plate 50 illustrated in FIG. 2 electrically connects the plurality of secondary batteries 40 in series or in parallel. In addition, the lead plate 50 electrically connects the plurality of the secondary batteries 40 and the control board 20. The lead plate 50 includes a first lead plate 51 and a second lead plate 52. The first lead plate 51 electrically connects two of the secondary batteries 40. The second lead plate 52 electrically connects four of the secondary batteries 40. It goes without saying that the number of the secondary batteries 40 electrically connected by the first lead plate 51 and the second lead plate 52 is not limited to the above numbers.

The holder 60 holds the plurality of secondary batteries 40 and the plurality of heat absorbing members 70. The holder 60 includes a first holder member 61 and a second holder member 62. The first holder member 61 holds the -Y side of the plurality of secondary batteries 40. The second holder member 62 holds the +Y side of the plurality of secondary batteries 40.

The heat absorbing member 70 absorbs heat of the secondary battery 40. The number of the heat absorbing members 70 is six, but it goes without saying that the number is not limited to six, and the number varies depending on the number and arrangement of the secondary batteries 40.

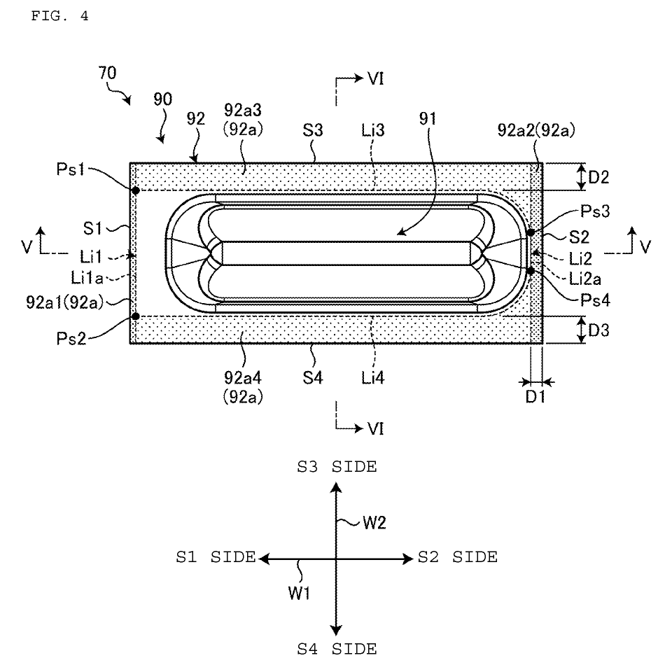

FIG. 4 is a plan view of the heat absorbing member 70. FIG. 4 corresponds to a plan view of the heat absorbing member 70 when the heat absorbing member 70 is viewed along the thickness direction of a flange portion 92 described later.

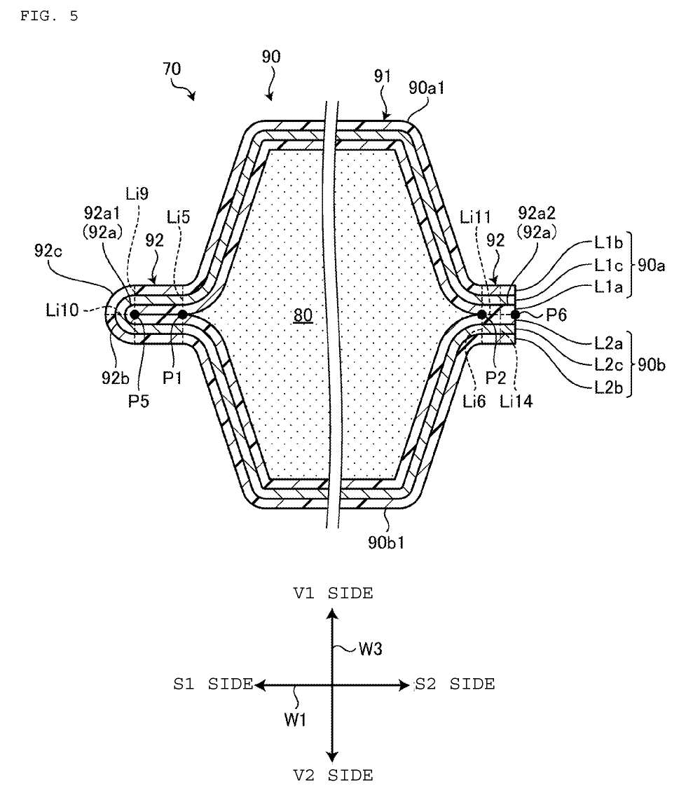

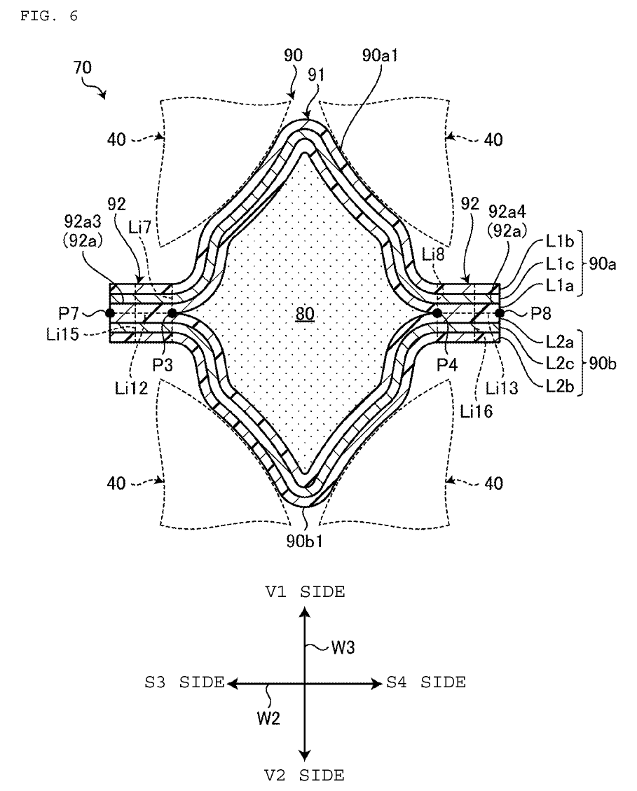

FIG. 5 is a view illustrating a sectional shape of the heat absorbing member 70 taken along line V-V illustrated in FIG. 4. FIG. 6 is a view illustrating a sectional shape of the heat absorbing member 70 taken along line VI-VI illustrated in FIG. 4. The sectional shapes in FIGS. 5 and 6 correspond to the sectional shape of the heat absorbing member 70 when cut along a plane along the thickness direction of the flange portion 92 described later.

Note that in the plan view of the heat absorbing member 70 illustrated in FIG. 4 and the sectional shape of the heat absorbing member 70 illustrated in FIG. 5, a first direction W1 corresponds to a direction in which line V-V illustrated in FIG. 4 extends. A “S1 side” indicated by an arrow in the first direction W1 corresponds to a side from an accommodating portion 91 to be described later toward a first side S1 of the flange portion 92 in the first direction W1 in the plan view of the heat absorbing member 70 illustrated in FIG. 4. A “S2 side” indicated by an arrow in the first direction W1 corresponds to a side from the accommodating portion 91 to be described later toward a second side S2 of the flange portion 92 in the first direction W1 in the plan view of the heat absorbing member 70 illustrated in FIG. 4.

In addition, in the plan view of the heat absorbing member 70 illustrated in FIG. 4 and the sectional shape of the heat absorbing member 70 illustrated in FIG. 6, a second direction W2 corresponds to a direction in which the line VI-VI illustrated in FIG. 4 extends. A “S3 side” indicated by an arrow in the second direction W2 corresponds to a side from the accommodating portion 91 to be described later toward a third side S3 of the flange portion 92 in the second direction W2 in the plan view of the heat absorbing member 70 illustrated in FIG. 4. A “S4 side” indicated by an arrow in the second direction W2 corresponds to a side from the accommodating portion 91 to be described later toward a fourth side S4 of the flange portion 92 in the second direction W2 in the plan view of the heat absorbing member 70 illustrated in FIG. 4.

In addition, in the sectional shape of the heat absorbing member 70 illustrated in FIGS. 5 and 6, a third direction W3 is a direction orthogonal to the first direction W1 and the second direction W2. A “V1 side” indicated by an arrow in the third direction W3 corresponds to a side from a second convex portion 90b1 to a first convex portion 90a1 of the accommodating portion 91 described later in the third direction W3 in the sectional shape of the heat absorbing member 70 illustrated in FIGS. 5 and 6. A "V2 side ” indicated by an arrow in the third direction W3 corresponds to a side from the first convex portion 90a1 to the second convex portion 90b1 of the accommodating portion 91 described later in the third direction W3 in the sectional shape of the heat absorbing member 70 illustrated in FIGS. 5 and 6.

In addition, in the plan view of the heat absorbing member 70 illustrated in FIG. 4, a first virtual line Li1 is a virtual line connecting the third side S3 and the fourth side S4 on the S1 side from the accommodating portion 91 in the first direction W1. In addition, the first virtual line portion Li1a included in the first virtual line Li1 corresponds to a portion of the first virtual line Li1 between a first connection point Ps1 between the first virtual line Li1 and a third virtual line Li3 to be described later and a second connection point Ps2 between the first virtual line Li1 and a fourth virtual line Li4 to be described later in the plan view of the heat absorbing member 70 illustrated in FIG. 4. The first virtual line portion Li1a overlaps with a fifth virtual point P5 (see FIG. 5) to be described later in the plan view of the heat absorbing member 70 illustrated in FIG. 4.

In the plan view of the heat absorbing member 70 illustrated in FIG. 4, a second virtual line Li2 is a virtual line connecting the third side S3 and the fourth side S4 on the S2 side from the accommodating portion 91 in the first direction W1. The second virtual line portion Li2a of the second virtual line Li2 corresponds to a portion of the second virtual line Li2 between a third connection point Ps3 between the second virtual line Li2 and the third virtual line Li3 to be described later and a fourth connection point Ps4 between the second virtual line Li2 and the fourth virtual line Li4 to be described later in the plan view of the heat absorbing member 70 illustrated in FIG. 4. The second virtual line portion Li2a overlaps with a second virtual point P2 (see FIG. 5) to be described later in the plan view of the heat absorbing member 70 illustrated in FIG. 4.

In addition, in the plan view of the heat absorbing member 70 illustrated in FIG. 4, the third virtual line Li3 is a virtual line connecting the first virtual line Li1 and the second virtual line Li2 on the S3 side from the center of the accommodating portion 91 in the second direction W2. The third virtual line Li3 overlaps with a third virtual point P3 (see FIG. 6) to be described later in the plan view of the heat absorbing member 70 illustrated in FIG. 4.

In the plan view of the heat absorbing member 70 illustrated in FIG. 4, the fourth virtual line Li4 is a virtual line connecting the first virtual line Li1 and the second virtual line Li2 on the S4 side from the center of the accommodating portion 91 in the second direction W2. The fourth virtual line Li4 overlaps with a fourth virtual point P4 (see FIG. 6) to be described later in the plan view of the heat absorbing member 70 illustrated in FIG. 4.

Note that in the plan view of the heat absorbing member 70 illustrated in FIG. 4, it goes without saying that the first virtual line Li1, the second virtual line Li2, the third virtual line Li3, and the fourth virtual line Li4 are not limited to the positions illustrated in FIG. 4. In addition, in the plan view of the heat absorbing member 70 illustrated in FIG. 4, the first virtual line Li1 and the second virtual line Li2 may be curved. In addition, in the plan view of the heat absorbing member 70 illustrated in FIG. 4, the third virtual line Li3 and the fourth virtual line Li4 may be linear.

The heat absorbing member 70 includes a heat absorbing agent 80 and an exterior body 90 that accommodates the heat absorbing agent 80.

The heat absorbing agent 80 contains a substance that absorbs heat generated from the secondary battery 40. A main component of the heat absorbing agent 80 is, for example, liquid such as water. The heat absorbing agent 80 may contain a gelling agent, a surfactant, and an anti-freezing agent. Note that the heat absorbing agent 80 has fluidity.

As illustrated in FIGS. 5 and 6, the exterior body 90 includes a first exterior portion 90a and a second exterior portion 90b.

The first exterior portion 90a has a first inner resin layer L1a (corresponding to a “first resin layer”), a first outer resin layer L1b, and a first metal layer L1c located between the first inner resin layer L1a and the first outer resin layer L1b. In the sectional shape of the heat absorbing member 70 illustrated in FIGS. 5 and 6, the first inner resin layer L1a, the first metal layer L1c, and the first outer resin layer L1b overlap in this order.

The second exterior portion 90b has a second inner resin layer L2a (corresponding to a “second resin layer”), a second outer resin layer L2b, and a second metal layer L2c located between the second inner resin layer L2a and the second outer resin layer L2b. In the sectional shape of the heat absorbing member 70 illustrated in FIGS. 5 and 6, the second inner resin layer L2a, the second metal layer L2c, and the second outer resin layer L2b overlap in this order. In the sectional shape of the heat absorbing member 70 illustrated in FIGS. 5 and 6, the first inner resin layer L1a and the second inner resin layer L2a face each other.

The material of the first inner resin layer L1a, the first outer resin layer L1b, the second inner resin layer L2a, and the second outer resin layer L2b is, for example, a simple substance of polyethylene terephthalate, but may be a synthetic resin containing at least one of nylon, polyethylene terephthalate, polypropylene, polyethylene, or polystyrene.

The material of the first metal layer L1c and the second metal layer L2c is, for example, aluminum. That is, melting points of first metal layer L1c and second metal layer L2c are higher than melting points of first inner resin layer L1a, first outer resin layer L1b, second inner resin layer L2a, and second outer resin layer L2b.

In addition, the exterior body 90 has the accommodating portion 91 that accommodates the heat absorbing agent 80 between the first inner resin layer L1a and the second inner resin layer L2a. The first exterior portion 90a and the second exterior portion 90b have the first convex portion 90a1 and the second convex portion 90b1 protruding toward the outside of the heat absorbing member 70 at a central portion in the first direction W1 and a central portion in the second direction W2 of the exterior body 90. The heat absorbing agent 80 is accommodated in a space inside the first convex portion 90a1 and the second convex portion 90b1. Hereinafter, a portion constituted by the first convex portion 90a1 and the second convex portion 90b1 corresponds to the accommodating portion 91.

In the sectional shape of the heat absorbing member 70 illustrated in FIG. 5, the accommodating portion 91 is located between a fifth virtual line Li5 and a sixth virtual line Li6 in the first direction W1. The fifth virtual line Li5 is a virtual line that includes a first virtual point P1 and extends along the third direction W3 in the sectional shape of the heat absorbing member 70 illustrated in FIG. 5. The first virtual point P1 is a point at which, in the sectional shape of the heat absorbing member 70 illustrated in FIG. 5, the first inner resin layer L1a and the second inner resin layer L2a overlap with each other when the S1 side is viewed from the inside of the accommodating portion 91 along the first direction W1.

The sixth virtual line Li6 is a virtual line that includes the second virtual point P2 and extends along the third direction W3 in the sectional shape of the heat absorbing member 70 illustrated in FIG. 5. The second virtual point P2 is a point at which, in the sectional shape of the heat absorbing member 70 illustrated in FIG. 5, the first inner resin layer L1a and the second inner resin layer L2a overlap with each other when the S2 side is viewed from the inside of the accommodating portion 91 along the first direction W1. Note that as described above, the second virtual point P2 overlaps with the second virtual line portion Li2a of the second virtual line Li2 in the plan view of the heat absorbing member 70 illustrated in FIG. 4.

In the sectional shape of the heat absorbing member 70 illustrated in FIG. 6, the accommodating portion 91 is located between a seventh virtual line Li7 and an eighth virtual line Li8 in the second direction W2. The seventh virtual line Li7 is a virtual line that includes the third virtual point P3 and extends along the third direction W3 in the sectional shape of the heat absorbing member 70 illustrated in FIG. 6. The third virtual point P3 is a point at which, in the sectional shape of the heat absorbing member 70 illustrated in FIG. 6, the first inner resin layer L1a and the second inner resin layer L2a overlap with each other when the S3 side is viewed from the inside of the accommodating portion 91 along the second direction W2. Note that as described above, the third virtual point P3 overlaps with the third virtual line Li3 in the plan view of the heat absorbing member 70 illustrated in FIG. 4.

The eighth virtual line Li8 is a virtual line that includes the fourth virtual point P4 and extends along the third direction W3 in the sectional shape of the heat absorbing member 70 illustrated in FIG. 6. The fourth virtual point P4 is a point at which, in the sectional shape of the heat absorbing member 70 illustrated in FIG. 6, the first inner resin layer L1a and the second inner resin layer L2a overlap with each other when the S4 side is viewed from the inside of the accommodating portion 91 along the second direction W2. Note that as described above, the fourth virtual point P4 overlaps with the fourth virtual line Li4 in the plan view of the heat absorbing member 70 illustrated in FIG. 4.

Further, the exterior body 90 has the flange portion 92 integrally with the accommodating portion 91. In the plan view of the heat absorbing member 70 illustrated in FIG. 4, the flange portion 92 is a portion provided over the entire circumference of the accommodating portion 91. In addition, the flange portion 92 is a portion where the first inner resin layer L1a and the second inner resin layer L2a overlap with each other (see FIGS. 5 and 6). Specifically, the flange portion 92 is continuous with the accommodating portion 91, and extends over the entire circumference of the accommodating portion 91 in the plan view of the heat absorbing member 70 illustrated in FIG. 4. In the plan view of the heat absorbing member 70 illustrated in FIG. 4, the outer peripheral edge of the flange portion 92 corresponds to the outer peripheral edge of the exterior body 90.

In the sectional shape of the heat absorbing member 70 illustrated in FIG. 5, the flange portion 92 is located on the S1 side from the fifth virtual line Li5 in the first direction W1 and on the S2 side from the sixth virtual line Li6 in the first direction W1. In the sectional shape of the heat absorbing member 70 illustrated in FIG. 6, the flange portion 92 is located on the S3 side from the seventh virtual line Li7 in the second direction W2 and on the S4 side from the eighth virtual line Li8 in the second direction W2.

In the plan view of the heat absorbing member 70 illustrated in FIG. 4, the outer peripheral edge of the flange portion 92 has a shape having the first side S1, the second side S2, the third side S3, and the fourth side S4. In the plan view of the heat absorbing member 70 illustrated in FIG. 4, the second side S2 is located on the opposite side to the first side S1 with the accommodating portion 91 interposed therebetween. The third side S3 connects a first end of the first side S1 and a first end of the second side S2. The fourth side S4 connects a second end of the first side S1 and a second end of the second side S2. In the plan view of the heat absorbing member 70 illustrated in FIG. 4, the fourth side S4 is located on the opposite side to the third side S3 with the accommodating portion 91 interposed therebetween. In the first embodiment, the first side S1, the second side S2, the third side S3, and the fourth side S4 are linear. Note that the first side S1, the second side S2, the third side S3, and the fourth side S4 may be curved.

In the plan view of the heat absorbing member 70 illustrated in FIG. 4, the flange portion 92 has an inner resin continuous portion 92a (corresponding to a “continuous portion”) in which the first inner resin layer L1a and the second inner resin layer L2a are continuous over the entire circumference of the accommodating portion 91. The inner resin continuous portion 92a is a portion where the first inner resin layer L1a and the second inner resin layer L2a are continuous in the flange portion 92. In other words, in the inner resin continuous portion 92a, a base material of the first inner resin layer L1a and a base material of the second inner resin layer L2a are integrated, and the first inner resin layer L1a and the second inner resin layer L2a are coupled.

The inner resin continuous portion 92a is a portion with a pattern in the plan view of the heat absorbing member 70 illustrated in FIG. 4. The inner resin continuous portion 92a surrounds the entire circumference of the accommodating portion 91 in the plan view of the heat absorbing member 70 illustrated in FIG. 4. In the plan view of the heat absorbing member 70 illustrated in FIG. 4, the outer peripheral edge of the inner resin continuous portion 92a is configured by the first side S1, the second side S2, the third side S3, and the fourth side S4. In addition, in the plan view of the heat absorbing member 70 illustrated in FIG. 4, the inner peripheral edge of the inner resin continuous portion 92a is configured by the first virtual line portion Li1a of the first virtual line Li1, the second virtual line portion Li2a of the second virtual line Li2, the third virtual line Li3, and the fourth virtual line Li4.

The inner resin continuous portion 92a integrally has a first continuous portion 92a1 (corresponding to a “first portion”), a second continuous portion 92a2 (corresponding to a “second portion” and a “first second portion”), a third continuous portion 92a3 (corresponding to a “second portion ” and a “second second portion”), and a fourth continuous portion 92a4 (corresponding to a “second portion ” and a “second second portion”).

In the plan view of the heat absorbing member 70 illustrated in FIG. 4, the first continuous portion 92a1 is a portion of the inner resin continuous portion 92a on the first side S1 side of the flange portion 92. Specifically, the first continuous portion 92a1 is a portion of the inner resin continuous portion 92a surrounded by the first side S1, the first virtual line Li1, the third side S3, and the fourth side S4 in the plan view of the heat absorbing member 70 illustrated in FIG. 4.

In the plan view of the heat absorbing member 70 illustrated in FIG. 4, the second continuous portion 92a2 is a portion of the inner resin continuous portion 92a on the second side S2 side of the flange portion 92. Specifically, the second continuous portion 92a2 is a portion of the inner resin continuous portion 92a surrounded by the second side S2, the second virtual line Li2, the third side S3, and the fourth side S4 in the plan view of the heat absorbing member 70 illustrated in FIG. 4.

In the plan view of the heat absorbing member 70 illustrated in FIG. 4, the third continuous portion 92a3 is a portion of the inner resin continuous portion 92a on the third side S3 side of the flange portion 92. Specifically, the third continuous portion 92a3 is a portion of the inner resin continuous portion 92a surrounded by the third side S3, the third virtual line Li3, the first virtual line Li1, and the second virtual line Li2 in the plan view of the heat absorbing member 70 illustrated in FIG. 4.

In the plan view of the heat absorbing member 70 illustrated in FIG. 4, the fourth continuous portion 92a4 is a portion of the inner resin continuous portion 92a on the fourth side S4 side of the flange portion 92. Specifically, the fourth continuous portion 92a4 is a portion of the inner resin continuous portion 92a surrounded by the fourth side S4, the fourth virtual line Li4, the first virtual line Li1, and the second virtual line Li2 in the plan view of the heat absorbing member 70 illustrated in FIG. 4.

In the sectional shape of the heat absorbing member 70 illustrated in FIG. 5, the first continuous portion 92a1 is located on the S1 side from a ninth virtual line Li9 in the first direction W1. The ninth virtual line Li9 is a virtual line that includes the fifth virtual point P5 and extends along the third direction W3 in the sectional shape of the heat absorbing member 70 illustrated in FIG. 5. Note that as described above, the fifth virtual point P5 overlaps with the first virtual line portion Li1a in the plan view of the heat absorbing member 70 illustrated in FIG. 4.

In addition, in the sectional shape of the heat absorbing member 70 illustrated in FIG. 5, a tenth virtual line Li10 is illustrated for convenience of description. The tenth virtual line Li10 is a virtual line that extends from the fifth virtual point P5 to the S1 side along the first direction W1 in the sectional shape of the heat absorbing member 70 illustrated in FIG. 5. The tenth virtual line Li10 corresponds to a boundary line between the first inner resin layer L1a and the second inner resin layer L2a (a boundary line for convenience of description: the same applies hereinafter), a boundary line between the first metal layer L1c and the second metal layer L2c, and a boundary line between the first outer resin layer L1b and the second outer resin layer L2b in the sectional shape of the heat absorbing member 70 illustrated in FIG. 5.

Note that in the sectional shape of the heat absorbing member 70 illustrated in FIG. 5, a solid line connecting the first virtual point P1 and the fifth virtual point P5 indicates a state where the surface of the first inner resin layer L1a and the surface of the second inner resin layer L2a overlap with each other in the flange portion 92. That is, in the sectional shape of the heat absorbing member 70 illustrated in FIG. 5, in the portion of the flange portion 92 between the fifth virtual line Li5 including the first virtual point P1 and the ninth virtual line Li9 including the fifth virtual point P5 in the first direction W1, the first inner resin layer L1a and the second inner resin layer L2a are not continuous, and the base material of the first inner resin layer L1a and the base material of the second inner resin layer L2a are not integrated.

In addition, the first continuous portion 92a1 is a portion of the inner resin continuous portion 92a entirely located inward of at least one of the first metal layer L1c or the second metal layer L2c in the sectional shape of the heat absorbing member 70 illustrated in FIG. 5. Specifically, in the sectional shape of the heat absorbing member 70 illustrated in FIG. 5, the entire first continuous portion 92a1 is located inward of a metal continuous portion 92b in which the first metal layer L1c and the second metal layer L2c are continuous. In the sectional shape of the heat absorbing member 70 illustrated in FIG. 5, the metal continuous portion 92b is a portion of the first metal layer L1c and the second metal layer L2c on the S1 side from the ninth virtual line Li9 in the first direction W1. The metal continuous portion 92b is a portion where the base material of the first metal layer L1c and the base material of the second metal layer L2c are integrated, and the first metal layer L1c and the second metal layer L2c continue without discontinuity. In the sectional shape of the heat absorbing member 70 illustrated in FIG. 5, the entire outer surface of the first continuous portion 92a1 overlaps with the inner surface of the metal continuous portion 92b. Note that the metal continuous portion 92b may be formed of one of the first metal layer L1c or the second metal layer L2c. In this case, a boundary between the first metal layer L1c and the second metal layer L2c is located between the fifth virtual line Li5 and the ninth virtual line Li9 in the first direction W1 in the sectional shape of the heat absorbing member 70 illustrated in FIG. 5.

In addition, in the sectional shape of the heat absorbing member 70 illustrated in FIG. 5, the entire first continuous portion 92a1 overlaps with the metal continuous portion 92b when the flange portion 92 is viewed from the S1 side. That is, in the sectional shape of the heat absorbing member 70 illustrated in FIG. 5, the first continuous portion 92a1 is not exposed to the outside of the exterior body 90 when the flange portion 92 is viewed from the S1 side. In addition, in the sectional shape of the heat absorbing member 70 illustrated in FIG. 5, the first inner resin layer L1a between the fifth virtual line Li5 and the ninth virtual line Li9 overlaps with the first metal layer L1c in the first direction W1. Further, in the sectional shape of the heat absorbing member 70 illustrated in FIG. 5, the second inner resin layer L2a between the fifth virtual line Li5 and the ninth virtual line Li9 overlaps with the second metal layer L2c in the first direction W1. Thus, in the sectional shape of the heat absorbing member 70 illustrated in FIG. 5, the first inner resin layer L1a and the second inner resin layer L2a between the fifth virtual line Li5 and the ninth virtual line Li9 in the first direction W1 are not exposed to the outside of the exterior body 90. Therefore, in the sectional shape of the heat absorbing member 70 illustrated in FIG. 5, on the S1 side from the fifth virtual line Li5 in the first direction W1, the first continuous portion 92a1, the first inner resin layer L1a, and the second inner resin layer L2a are not exposed to the outside of the exterior body 90.

In the sectional shape of the heat absorbing member 70 illustrated in FIG. 5, the second continuous portion 92a2 is located on the S2 side from the sixth virtual line Li6 in the first direction W1. In addition, in the sectional shape of the heat absorbing member 70 illustrated in FIG. 5, an eleventh virtual line Li11 is illustrated for convenience of description. The eleventh virtual line Li11 is a virtual line that extends from the second virtual point P2 to the S2 side along the first direction W1 in the sectional shape of the heat absorbing member 70 illustrated in FIG. 5. In the sectional shape of the heat absorbing member 70 illustrated in FIG. 5, the eleventh virtual line Li11 corresponds to the boundary line between the first inner resin layer L1a and the second inner resin layer L2a.

In addition, the second continuous portion 92a2 has a portion exposed to the outside of the exterior body 90 in the sectional shape of the heat absorbing member 70 illustrated in FIG. 5. Specifically, in the sectional shape of the heat absorbing member 70 illustrated in FIG. 5, a part of the second continuous portion 92a2 is exposed to the outside when the flange portion 92 is viewed from the S2 side to the S1 side along the first direction W1. In the sectional shape of the heat absorbing member 70 illustrated in FIG. 5, the second continuous portion 92a2 is sandwiched between the first metal layer L1c and the second metal layer L2c in a state where the first metal layer L1c and the second metal layer L2c are spaced apart from each other.

In the sectional shape of the heat absorbing member 70 illustrated in FIG. 6, the third continuous portion 92a3 is located on the S3 side from the seventh virtual line Li7 in the second direction W2. In addition, in the sectional shape of the heat absorbing member 70 illustrated in FIG. 6, a twelfth virtual line Li12 is illustrated for convenience of description. The twelfth virtual line Li12 is a virtual line that extends from the third virtual point P3 to the S3 side along the second direction W2 in the sectional shape of the heat absorbing member 70 illustrated in FIG. 6. In the sectional shape of the heat absorbing member 70 illustrated in FIG. 6, the twelfth virtual line Li12 corresponds to the boundary line between the first inner resin layer L1a and the second inner resin layer L2a.

The third continuous portion 92a3 has a portion exposed to the outside of the exterior body 90 in the sectional shape of the heat absorbing member 70 illustrated in FIG. 6. Specifically, in the sectional shape of the heat absorbing member 70 illustrated in FIG. 6, a part of the third continuous portion 92a3 is exposed to the outside of the exterior body 90 when the flange portion 92 is viewed from the S3 side to the S4 side along the second direction W2. In the sectional shape of the heat absorbing member 70 illustrated in FIG. 6, the third continuous portion 92a3 is sandwiched between the first metal layer L1c and the second metal layer L2c in a state where the first metal layer L1c and the second metal layer L2c are spaced apart from each other.

In the sectional shape of the heat absorbing member 70 illustrated in FIG. 6, the fourth continuous portion 92a4 is located on the S4 side from the eighth virtual line Li8 in the second direction W2. In addition, in the sectional shape of the heat absorbing member 70 illustrated in FIG. 6, a thirteenth virtual line Li13 is illustrated for convenience of description. The thirteenth virtual line Li13 is a virtual line that extends from the fourth virtual point P4 to the S4 side along the second direction W2 in the sectional shape of the heat absorbing member 70 illustrated in FIG. 6. In the sectional shape of the heat absorbing member 70 illustrated in FIG. 6, the thirteenth virtual line Li13 corresponds to the boundary line between the first inner resin layer L1a and the second inner resin layer L2a.

The fourth continuous portion 92a4 has a portion exposed to the outside of the exterior body 90 in the sectional shape of the heat absorbing member 70 illustrated in FIG. 6. Specifically, in the sectional shape of the heat absorbing member 70 illustrated in FIG. 6, a part of the third continuous portion 92a3 is exposed to the outside of the exterior body 90 when the flange portion 92 is viewed from the S4 side to the S3 side along the second direction W2. In the sectional shape of the heat absorbing member 70 illustrated in FIG. 6, the fourth continuous portion 92a4 is sandwiched between the first metal layer L1c and the second metal layer L2c in a state where the first metal layer L1c and the second metal layer L2c are spaced apart from each other.

In addition, in the sectional shape of the heat absorbing member 70 illustrated in FIG. 5, an outer resin continuous portion 92c in which the first outer resin layer L1b and the second outer resin layer L2b are continuous is provided on the S1 side of the flange portion 92. In the sectional shape of the heat absorbing member 70 illustrated in FIG. 5, the outer resin continuous portion 92c is located outside the metal continuous portion 92b. In the sectional shape of the heat absorbing member 70 illustrated in FIG. 5, the outer resin continuous portion 92c is a portion of the first outer resin layer L1b and the second outer resin layer L2b on the S1 side from the ninth virtual line Li9 in the first direction W1. In the outer resin continuous portion 92c, a base material of the first outer resin layer L1b and a base material of the second outer resin layer L2b are integrated, and the first outer resin layer L1b and the second outer resin layer L2b continue without discontinuity. In the sectional shape of the heat absorbing member 70 illustrated in FIG. 5, the entire outer surface of the metal continuous portion 92b overlaps with the inner surface of the outer resin continuous portion 92c. Note that the outer resin continuous portion 92c may be formed of one of the first outer resin layer L1b or the second outer resin layer L2b. In this case, a boundary between the first outer resin layer L1b and the second outer resin layer L2b is located between the fifth virtual line Li5 and the ninth virtual line Li9 in the first direction W1 in the sectional shape of the heat absorbing member 70 illustrated in FIG. 5.

In the sectional shape of the heat absorbing member 70 illustrated in FIG. 5, on the S2 side of the flange portion 92, the first outer resin layer L1b and the second outer resin layer L2b are spaced apart from each other in a state of sandwiching the first metal layer L1c and the second metal layer L2c.

In the sectional shape of the heat absorbing member 70 illustrated in FIG. 6, on the S3 side and the S4 side of the flange portion 92, the first outer resin layer L1b and the second outer resin layer L2b are spaced apart from each other in a state of sandwiching the first metal layer L1c and the second metal layer L2c.

Inaddition, in the plan view of the heat absorbing member 70 illustrated in FIG. 4, a first distance D1 between the second side S2 and the inner peripheral edge of the second continuous portion 92a2 is shorter than a second distance D2 between the third side S3 and the inner peripheral edge of the third continuous portion 92a3 and a third distance D3 between the fourth side S4 and the inner peripheral edge of the fourth continuous portion 92a4. In addition, the second distance D2 and the third distance D3 are substantially equal to each other. The inner peripheral edge of the second continuous portion 92a2 corresponds to the second virtual line portion Li2a in the plan view of the heat absorbing member 70 illustrated in FIG. 4. The inner peripheral edge of the third continuous portion 92a3 corresponds to the third virtual line Li3 in the plan view of the heat absorbing member 70 illustrated in FIG. 4. The inner peripheral edge of the fourth continuous portion 92a4 corresponds to the fourth virtual line Li4 in the plan view of the heat absorbing member 70 illustrated in FIG. 4. Note that in the plan view of the heat absorbing member 70 illustrated in FIG. 4, the first distance D1 corresponds to the shortest distance between the inner peripheral edge of the second continuous portion 92a2 and the outer peripheral edge of the portion of the second continuous portion 92a2 exposed to the outside of the exterior body 90. In addition, in the plan view of the heat absorbing member 70 illustrated in FIG. 4, the second distance D2 corresponds to the shortest distance between the inner peripheral edge of the third continuous portion 92a3 and the outer peripheral edge of the portion of the third continuous portion 92a3 exposed to the outside of the exterior body 90. Further, in the plan view of the heat absorbing member 70 illustrated in FIG. 4, the third distance D3 corresponds to the shortest distance between the inner peripheral edge of the fourth continuous portion 92a4 and the outer peripheral edge of the portion of the fourth continuous portion 92a4 exposed to the outside of the exterior body 90.

Next, a manufacturing step of the heat absorbing member 70 will be described.

FIG. 7 is a perspective view illustrating the exterior body 90 before accommodating the heat absorbing agent 80. Before accommodating the heat absorbing agent 80, in the exterior body 90, the first exterior portion 90a and the second exterior portion 90b are continuous at a portion corresponding to the first side S1 (a portion indicated by a broken line) in a state where the first inner resin layer L1a and the second inner resin layer L2a do not face each other. The first convex portion 90a1 and the second convex portion 90b1 are formed by press working, for example. That is, before accommodating the heat absorbing agent 80, the exterior body 90 is formed by performing press working on one sheet member.

The manufacturing step of the heat absorbing member 70 includes an injection step, a bending step, and a welding step. The injection step, the bending step, and the welding step are performed in this order. The injection step is a step of injecting the heat absorbing agent 80 into at least one of the first convex portion 90a1 or the second convex portion 90b1 of the exterior body 90 illustrated in FIG. 7.

The bending step is a step of bending the exterior body 90 at a portion (a portion indicated by a broken line) corresponding to the first side S1 of the exterior body 90 illustrated in FIG. 7. The exterior body 90 is bent in a state where the first inner resin layer L1a and the second inner resin layer L2a face each other and overlap with each other (see FIGS. 5 and 6).

The first continuous portion 92a1 of the inner resin continuous portion 92a, the metal continuous portion 92b, and the outer resin continuous portion 92c illustrated in FIG. 5 are formed by the bending step. That is, the first continuous portion 92a1, the metal continuous portion 92b, and the outer resin continuous portion 92c correspond to a portion where the first exterior portion 90a and the second exterior portion 90b are continuous in the exterior body 90 before accommodating the heat absorbing agent 80.

The welding step is a step of welding (for example, ultrasonic welding) the first inner resin layer L1a and the second inner resin layer L2a. The second continuous portion 92a2, the third continuous portion 92a3, and the fourth continuous portion 92a4 of the inner resin continuous portion 92a illustrated in FIGS. 4, 5, and 6 are formed by the welding step. That is, the second continuous portion 92a2, the third continuous portion 92a3, and the fourth continuous portion 92a4 correspond to a portion where the first inner resin layer L1a and the second inner resin layer L2a are continuous due to the welding-based joining of the first inner resin layer L1a and the second inner resin layer L2a. When the welding step is completed, the accommodating portion 91 and the flange portion 92 are formed, and the heat absorbing member 70 is completed.

Next, the arrangement of the heat absorbing member 70 will be described.

The heat absorbing member 70 is surrounded by four secondary batteries 40. Specifically, as illustrated in FIG. 6, the outer peripheral surfaces of two secondary batteries 40 are in contact with the outer surface of the first convex portion 90a1, and the outer peripheral surfaces of two secondary batteries 40 are in contact with the outer surface of the second convex portion 90b1.

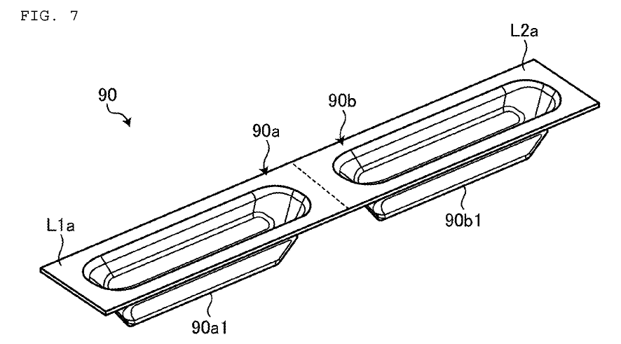

FIG. 8 is a view illustrating the arrangement of the heat absorbing member 70 when the secondary battery 40 and the heat absorbing member 70 are viewed along a direction orthogonal to the axial direction in which the center axis CL of the secondary battery 40 extends. In FIG. 8, the axial direction is along the Y direction, and the direction orthogonal to the axial direction is along the Z direction.

Two heat absorbing members 70 are arranged in the axial direction. The longitudinal direction of the heat absorbing member 70 is along the axial direction. Two heat absorbing members 70 arranged along the axial direction are spaced apart from each other.

In addition, the heat absorbing member 70 is arranged in an orientation in which the first continuous portion 92a1 is closer to the end of the secondary battery 40 (specifically, one of the positive electrode terminal 40a and the negative electrode terminal 40b) than the second continuous portion 92a2, the third continuous portion 92a3, and the fourth continuous portion 92a4 in the axial direction. That is, two heat absorbing members 70 arranged along the axial direction overlap with the secondary battery 40 in FIG. 8, and are arranged in an orientation in which the second side S2 sides of the flange portions 92 face each other and the first side S1 sides of the flange portions 92 face opposite each other. Furthermore, a space between two heat absorbing members 70 is located in the central portion of the secondary battery 40 in the axial direction.

Next, an operation of the battery pack 1 in a case where one secondary battery 40 abnormally generates heat will be described.

In a case where the secondary battery 40 abnormally generates heat, the temperature of the exterior body 90 of the heat absorbing member 70 in contact with the secondary battery 40 that has abnormally generated heat rises, and the second continuous portion 92a2, the third continuous portion 92a3, and the fourth continuous portion 92a4 illustrated in FIGS. 4, 5, and 6 melt.

As described above, in the sectional shape of the heat absorbing member 70 illustrated in FIG. 5, the entire first continuous portion 92a1 is located inward of the metal continuous portion 92b. That is, in the sectional shape of the heat absorbing member 70 illustrated in FIG. 5, the first continuous portion 92a1 is not exposed to the outside of the exterior body 90 when the flange portion 92 is viewed from the S1 side. In addition, the melting points of the first metal layer L1c and the second metal layer L2c (metal continuous portion 92b) are higher than the melting point of the inner resin continuous portion 92a. Thus, the flange portion 92 is not cleaved from the first side S1 side.

On the other hand, as described above, in the sectional shape of the heat absorbing member 70 illustrated in FIGS. 5 and 6, a part of the second continuous portion 92a2, a part of the third continuous portion 92a3, and a part of the fourth continuous portion 92a4 are exposed to the outside of the exterior body 90. Thus, when the inner resin continuous portion 92a is melted, the flange portion 92 is cleaved from the second side S2 side, the third side S3 side, and the fourth side S4 side.

In addition, in FIG. 8, the distance D1 corresponds to a distance along the axial direction between the inner peripheral edge of the second continuous portion 92a2 and the outer peripheral edge of the portion of the second continuous portion 92a2 exposed to the outside of the exterior body 90. In FIG. 8, the distance D2 corresponds to a distance along a direction orthogonal to the axial direction between the inner peripheral edge of the third continuous portion 92a3 and the outer peripheral edge of the portion of the third continuous portion 92a3 exposed to the outside of the exterior body 90. In FIG. 8, the distance D3 corresponds to a distance along a direction orthogonal to the axial direction between the inner peripheral edge of the fourth continuous portion 92a4 and the outer peripheral edge of the portion of the fourth continuous portion 92a4 exposed to the outside of the exterior body 90. As described above, the first distance D1 is shorter than the second distance D2 and the third distance D3.

Thus, as described above, the portion of the flange portion 92 on the second side S2 side is cleaved earlier than the portion on the third side S3 side and the portion on the fourth side S4 side. When the portion of the flange portion 92 on the second side S2 side is cleaved, the heat absorbing agent 80 leaks from the portion of the flange portion 92 on the second side S2 side.

As indicated by an arrow in FIG. 8, the heat absorbing agent 80 leaking from the portion of the flange portion 92 on the second side S2 side flows toward between two heat absorbing members 70, adheres to the axial central portion of the secondary battery 40, and absorbs the heat of the secondary battery 40. Subsequently, the heat absorbing agent 80 spreads along the outer peripheral surface of the secondary battery 40 and absorbs the heat of the secondary battery 40.

Further, the portion on the third side S3 side and the portion on the fourth side S4 side in the flange portion 92 are further cleaved, so that the heat absorbing agent 80 further leaks out. The leaked heat absorbing agent 80 flows along the outer peripheral surface of the secondary battery 40 and absorbs the heat of the secondary battery 40.

Note that when the secondary battery 40 abnormally generates heat, the cleavage valve 43b illustrated in FIG. 3 may be opened and a relatively high-temperature gas may be ejected from the hole 43a1. In addition, at this time, a relatively high-temperature gas may be ejected from the cleaved battery thin-walled portion 42a. At this time, the temperature on both end sides of the secondary battery 40 may be higher than the temperature at the central portion of the secondary battery 40 in the axial direction. Also in this case, as described above, the first continuous portion 92a1 overlaps with the metal continuous portion 92b when the flange portion 92 is viewed from the first side S1 side, and is not exposed to the outside of the exterior body 90. Thus, the portion of the flange portion 92 on the first side S1 side is not cleaved.

At this time, a portion on the third side S3 side or a portion on the fourth side S4 side close to a high-temperature portion in the secondary battery 40 is cleaved. Subsequently, the portion of the second side S2 is cleaved.

Thus, even in a case where the temperature on both end sides of the secondary battery 40 is higher than the temperature at the central portion of the secondary battery 40 in the axial direction, the heat absorbing agent 80 absorbs the heat of the secondary battery 40 as described above.

If a portion of the flange portion 92 on the first side S1 side is cleaved earlier than other portions, the leaked heat absorbing agent 80 flows toward both end sides of the secondary battery 40 in the axial direction. Thus, as compared with a case where the portion of the flange portion 92 on the second side S2 side is cleaved early as described above, a contact area between the heat absorbing agent 80 and the secondary battery 40 is small, and the heat of the secondary battery 40 is hardly absorbed.

In the battery pack 1 of this embodiment, as described above, when the central portion of the secondary battery 40 is at a high temperature, the portion of the flange portion 92 on the second side S2 side is cleaved early. In addition, when both ends of the secondary battery 40 are at a high temperature, the portion on the third side S3 or the portion on the fourth side S4 is cleaved, and subsequently the portion on the second side S2 is cleaved. As a result, it is possible to improve the heat absorption efficiency of the heat absorbing agent 80 at the time of abnormal heat generation of the secondary battery 40.

Next, a battery pack 1 according to a modification of the first embodiment of the present disclosure will be described mainly with respect to portions different from the battery pack 1 of the first embodiment.

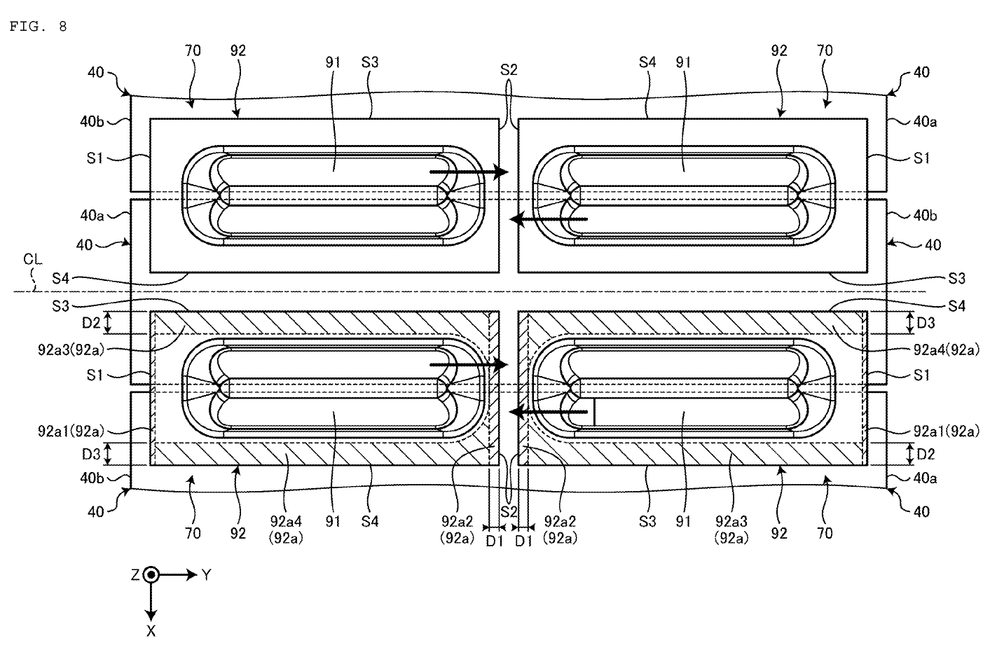

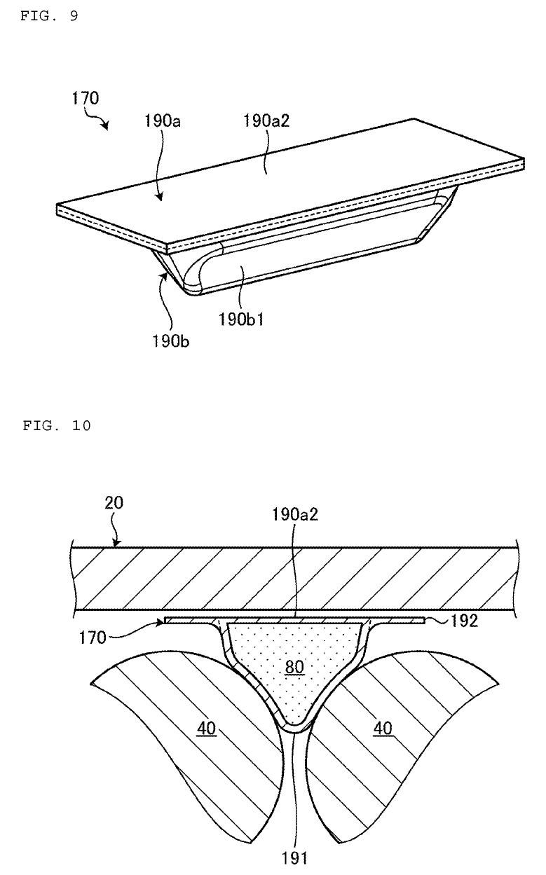

FIG. 9 is a perspective view of a heat absorbing member 170 of the battery pack 1 according to the modification of the first embodiment of the present disclosure. FIG. 10 is a partial sectional view of a battery unit 30 according to the modification of the first embodiment. FIG. 10 is a view illustrating a sectional shape of the battery unit 30 taken along a plane orthogonal to the Y direction.

The heat absorbing member 170 according to the present modification does not have the first convex portion 90a1 of the heat absorbing member 70 of the first embodiment. An outer surface of a first exterior portion 190a of the heat absorbing member 170 has a flat surface 190a2. The heat absorbing member 170 has a second convex portion 190b1 of a second exterior portion 190b.

In this case, as illustrated in FIG. 10, the flat surface 190a2 and the control board 20 face each other, so that the heat absorbing member 170 can be arranged between two secondary batteries 40 and the control board 20. An accommodating portion 191 is in contact with two secondary batteries 40. In addition, by causing the flat surfaces 190a2 of the first exterior portions 190a of two heat absorbing members 170 to overlap with each other, the two heat absorbing members 170 can be arranged in a state of being surrounded by four secondary batteries 40, similarly to the heat absorbing member 70 of the first embodiment described above.

In addition, also in the heat absorbing member 170 of the present modification, similarly to the heat absorbing member 70 of the first embodiment, the portion of the flange portion 192 on the second side S2 side is cleaved early at the time of abnormal heat generation of the secondary battery 40. Therefore, also in the battery pack 1 of the present modification, similarly to the battery pack 1 of the first embodiment, it is possible to improve the heat absorption efficiency of the heat absorbing agent 80 at the time of abnormal heat generation of the secondary battery 40.

Note that the second continuous portion 92a2 may be located between the sixth virtual line Li6 and a fourteenth virtual line Li14 in the first direction W1 in the sectional shape of the heat absorbing member 70 illustrated in FIG. 5. The fourteenth virtual line Li14 is a virtual line which is located between a sixth virtual point P6 which is an end point on the S2 side of the eleventh virtual line Li11 and the second virtual point P2 in the first direction W1 in the sectional shape of the heat absorbing member 70 illustrated in FIG. 5, and extends along the third direction W3. In this case, in the sectional shape of the heat absorbing member 70 illustrated in FIG. 5, in the portion of the flange portion 92 on the S2 side from the fourteenth virtual line Li14 in the first direction W1, the first inner resin layer L1a and the second inner resin layer L2a are not welded, and the first inner resin layer L1a and the second inner resin layer L2a are not continuous.

In addition, in the sectional shape of the heat absorbing member 70 illustrated in FIG. 6, the third continuous portion 92a3 may be located between the seventh virtual line Li7 and a fifteenth virtual line Li15 in the second direction W2. The fifteenth virtual line Li15 is a virtual line which is located between a seventh virtual point P7 which is an end point on the S3 side of the twelfth virtual line Li12 and the third virtual point P3 in the second direction W2 in the sectional shape of the heat absorbing member 70 illustrated in FIG. 6, and extends along the third direction W3. In this case, in the sectional shape of the heat absorbing member 70 illustrated in FIG. 6, in the portion of the flange portion 92 on the S3 side from the fifteenth virtual line Li15 in the second direction W2, the first inner resin layer L1a and the second inner resin layer L2a are not welded, and the first inner resin layer L1a and the second inner resin layer L2a are not continuous.

In addition, in the sectional shape of the heat absorbing member 70 illustrated in FIG. 6, the fourth continuous portion 92a4 may be located between the eighth virtual line Li8 and a sixteenth virtual line Li16 in the second direction W2. The sixteenth virtual line Li16 is a virtual line which is located between an eighth virtual point P8 which is an end point on the S4 side of the thirteenth virtual line Li13 and the fourth virtual point P4 in the second direction W2 in the sectional shape of the heat absorbing member 70 illustrated in FIG. 6, and extends along the third direction W3. In this case, in the sectional shape of the heat absorbing member 70 illustrated in FIG. 6, in the portion of the flange portion 92 on the S4 side from the sixteenth virtual line Li16 in the second direction W2, the first inner resin layer L1a and the second inner resin layer L2a are not welded, and the first inner resin layer L1a and the second inner resin layer L2a are not continuous.

Next, a battery pack 1 according to a second embodiment of the present disclosure will be described mainly with respect to portions different from those of the first embodiment.

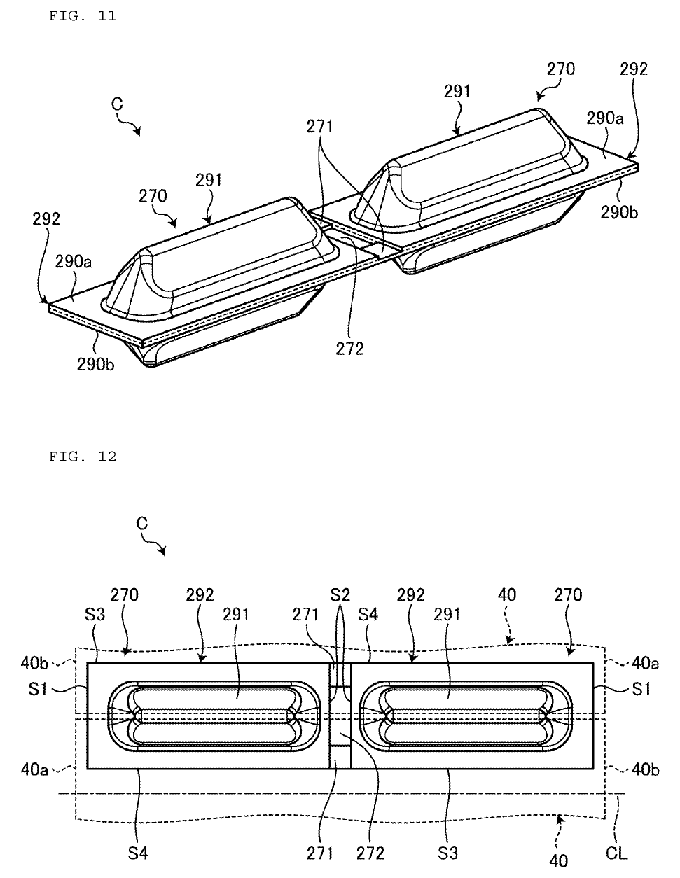

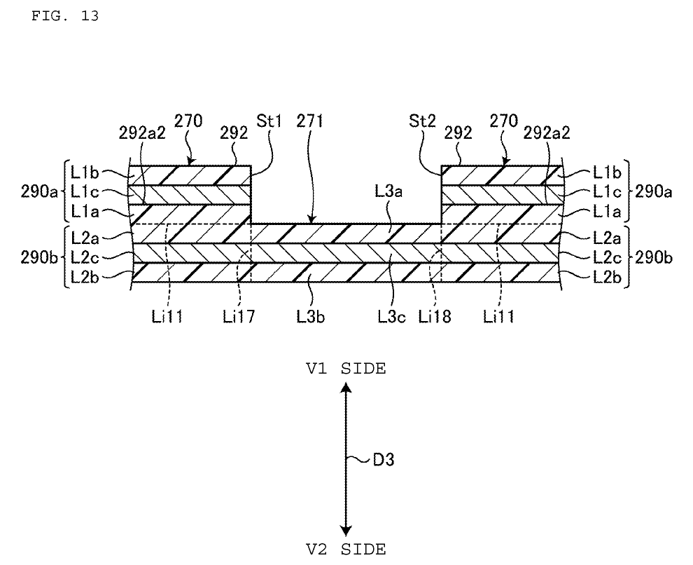

FIG. 11 is a perspective view of one set of heat absorbing members C included in the battery pack 1 according to the second embodiment of the present disclosure. FIG. 12 is a plan view of one set of heat absorbing members C illustrated in FIG. 11. The battery pack 1 of the second embodiment includes a plurality of (for example, three) sets of heat absorbing members C. One set of heat absorbing members C integrally includes two heat absorbing members 270 and a coupling portion 271.

The heat absorbing member 270 is configured similarly to the heat absorbing member 70 of the first embodiment. The heat absorbing member 270 includes an accommodating portion 291 and a flange portion 292. In one set of heat absorbing members C, two heat absorbing members 270 are arranged along the longitudinal direction of the heat absorbing member 270 in an orientation in which the second side S2 sides of the flange portions 292 face each other and the first side S1 sides of the flange portions 292 face opposite each other.

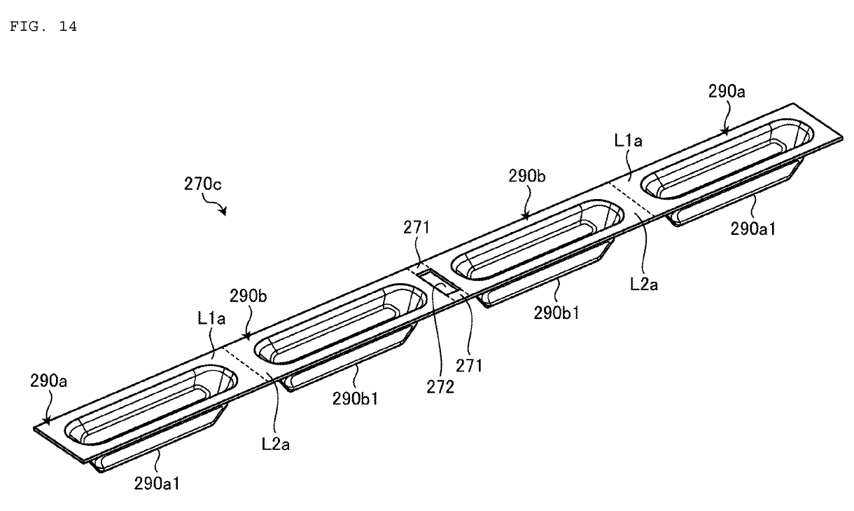

FIG. 13 is a view mainly illustrating a sectional shape of the coupling portion 271 in a sectional shape of one set of heat absorbing members C when cut along a plane along a thickness direction of the flange portion 292 of the heat absorbing member 270. The coupling portion 271 couples the portions on the second side S2 side (that is, a second continuous portion 292a2 side) of the flange portions 292 in two heat absorbing members 270 to each other. In addition, the coupling portion 271 couples second exterior portions 290b of two heat absorbing members 270 to each other. In the sectional shape illustrated in FIG. 13, a seventeenth virtual line Li17 and an eighteenth virtual line Li18 are illustrated for convenience of description. The seventeenth virtual line Li17 is a virtual line that extends along the third direction W3 in the sectional shape illustrated in FIG. 13 and overlaps with an end surface St1 on the second side S2 side in the flange portion 292 of one heat absorbing member 270 of two heat absorbing members 270. The seventeenth virtual line Li17 corresponds to a boundary line between one heat absorbing member 270 of two heat absorbing members 270 and the coupling portion 271. The eighteenth virtual line Li18 is a virtual line that extends along the third direction W3 in the sectional shape illustrated in FIG. 13 and overlaps with an end surface St2 on the second side S2 side in the flange portion 292 of the other heat absorbing member 270 of the two heat absorbing members 270. The eighteenth virtual line Li18 corresponds to a boundary line between the other heat absorbing member 270 of the two heat absorbing members 270 and the coupling portion 271.

The coupling portion 271 has a first coupling resin layer L3a, a second coupling resin layer L3b, and a coupling metal layer L3c between the first coupling resin layer L3a and the second coupling resin layer L3b. In the sectional shape of the coupling portion 271 illustrated in FIG. 13, the first coupling resin layer L3a, the coupling metal layer L3c, and the second coupling resin layer L3b overlap in this order.

The first coupling resin layer L3a couples the second inner resin layers L2a of the second exterior portions 290b of two heat absorbing members 270 to each other. The first coupling resin layer L3a is continuous with and integrated with the second inner resin layers L2a of the two heat absorbing members 270. In addition, the second coupling resin layer L3b couples the second outer resin layers L2b of the second exterior portions 290b of the two heat absorbing members 270 to each other. The second coupling resin layer L3b is continuous with and integrated with the second outer resin layers L2b of the two heat absorbing members 270. The coupling metal layer L3c couples the second metal layers L2c of the second exterior portions 290b of the two heat absorbing members 270 to each other. The coupling metal layer L3c is continuous with and integrated with the second metal layers L2c of the two heat absorbing members 270. Note that the coupling portion 271 may couple first exterior portions 290a of the two heat absorbing members 270 to each other.

In addition, as illustrated in FIGS. 11 and 12, one set of heat absorbing members C has an opening portion 272. The opening portion 272 is located between portions on the second side S2 side (that is, the second continuous portion 292a2 side) of the flange portions 292 in two heat absorbing members 270.

Next, a manufacturing step of one set of heat absorbing members C will be described.

FIG. 14 is a perspective view illustrating an exterior body 270c of one set of heat absorbing members C before accommodating the heat absorbing agent 80. In the exterior body 270c of one set of heat absorbing members C, the first exterior portions 290a and the second exterior portions 290b of two heat absorbing members 270, and the coupling portion 271 are integrated. In the exterior body 270c, the first inner resin layer L1a and the second inner resin layer L2a do not face each other.

As described above, the coupling portion 271 couples the second exterior portions 290b of the two heat absorbing members 270 to each other. A first convex portion 290a1 and a second convex portion 290b1 of the two heat absorbing members 270, and the opening portion 272 are formed by press working, for example. That is, before accommodating the heat absorbing agent 80, the exterior body 270c is formed by applying press working to one sheet member.

By performing the injection step, the bending step, and the welding step described above on the exterior body 270c, one set of heat absorbing members C is completed.

Next, the arrangement of the heat absorbing member 270 will be described.

Similarly to the heat absorbing member 270 of the first embodiment, one set of heat absorbing members C is surrounded by four secondary batteries 40. In addition, as illustrated in FIG. 12, in one set of heat absorbing members C, two heat absorbing members 270 are arranged in an orientation along the axial direction.

Each of the two heat absorbing members 270 has an orientation in which the portion on the first side S1 side in the flange portion 292 is closer to the end of the secondary battery 40 than the portion on the second side S2 side in the axial direction. The opening portion 272 is located at the central portion of the secondary battery 40 in the axial direction.

Next, an operation of the battery pack 1 in a case where one secondary battery 40 abnormally generates heat will be described.

In a case where one secondary battery 40 abnormally generates heat, in one set of heat absorbing members C in contact with one secondary battery 40, similarly to the heat absorbing member 70 of the first embodiment, in the flange portions 292 of two heat absorbing members 270, first, the portion on the second side S2 side is cleaved, and the heat absorbing agent 80 leaks from the portion on the second side S2 side.

The heat absorbing agent 80 leaking from the portion of the flange portion 292 on the second side S2 side flows through the opening portion 272, adheres to the axial central portion of the secondary battery 40, and absorbs the heat of the secondary battery 40. Subsequently, the heat absorbing agent 80 spreads along the outer peripheral surface of the secondary battery 40 and absorbs the heat of the secondary battery 40.

Further, similarly to the heat absorbing member 70 of the first embodiment, the portion on the third side S3 side and the portion on the fourth side S4 side in the flange portion 292 are further cleaved, so that the heat absorbing agent 80 further leaks out. The leaked heat absorbing agent 80 flows along the outer peripheral surface of the secondary battery 40 and absorbs the heat of the secondary battery 40.

Therefore, also in the battery pack 1 of the second embodiment, similarly to the battery pack 1 of the first embodiment, it is possible to improve the heat absorption efficiency of the heat absorbing agent 80 at the time of abnormal heat generation of the secondary battery 40.

Note that the above-described embodiments and modification are for facilitating understanding of the present disclosure, and are not intended to interpret the present disclosure in a limited manner. The present disclosure may be modified or improved without departing from the spirit thereof, and the present disclosure includes equivalents thereof.

Note that the present disclosure may be a combination of the following configurations according to an embodiment.

(1)

A battery pack including:

a plurality of secondary batteries each having a cylindrical shape; and

a heat absorbing member that has a heat absorbing agent and an exterior body accommodating the heat absorbing agent, in which

the exterior body includes

a first exterior portion that has a first resin layer and a first metal layer overlapping with the first resin layer, and

a second exterior portion that has a second resin layer facing the first resin layer and a second metal layer overlapping with the second resin layer,

the exterior body integrally includes

an accommodating portion that accommodates the heat absorbing agent between the first resin layer and the second resin layer, and

a flange portion in which the first resin layer and the second resin layer overlap with each other over an entire circumference of the accommodating portion,

the flange portion has a continuous portion in which the first resin layer and the second resin layer are continuous over an entire circumference around the accommodating portion,

the continuous portion includes a first portion and a second portion,

the first portion is located inward of at least one of the first metal layer or the second metal layer in a sectional shape of the heat absorbing member when cut along a plane along a thickness direction of the flange portion,

the second portion has a portion exposed to outside of the exterior body in the sectional shape of the heat absorbing member when cut along the plane along the thickness direction of the flange portion, and

the heat absorbing member is arranged in an orientation in which the first portion is closer to an end of each of the secondary batteries than the second portion in an axial direction in which a center axis of each of the secondary batteries extends.

(2)

The battery pack according to (1), in which

two heat absorbing members identical to the heat absorbing member are provided, and

the two heat absorbing members are arranged along the axial direction and spaced apart from each other.

(3)

The battery pack according to (1) or (2), in which

a space between the two heat absorbing members is located in a central portion of each of the secondary batteries in the axial direction.

(4)

The battery pack according to any one of (1) to (3), including:

one set of heat absorbing members that integrally includes the two heat absorbing members and a coupling portion that couples portions on the second portion side of the flange portions in the two heat absorbing members to each other, in which

the one set of heat absorbing members includes an opening portion between the portions on the second portion side of the flange portions in the two heat absorbing members.

(5)

The battery pack according to (4), in which

the opening portion is located in a central portion of each of the secondary batteries in the axial direction.

(6)

The battery pack according to any one of (1) to (5), in which

the second portion includes

a first second portion that is a portion on a side opposite to the first portion in the axial direction, and

a second second portion that is closer to an end of each of the secondary batteries than the first second portion, and

when the heat absorbing member is viewed along a direction orthogonal to the axial direction, a distance along the axial direction between an inner peripheral edge of the first second portion and an outer peripheral edge of a portion exposed to outside of the first second portion is shorter than a distance along a direction orthogonal to the axial direction between an inner peripheral edge of the second second portion and an outer peripheral edge of a portion exposed to outside of the second second portion.

### DESCRIPTION OF REFERENCE SYMBOLS

1: Battery pack

40: Secondary battery

70: Heat absorbing member

80: Heat absorbing agent

90: Exterior body

91: Accommodating portion

92: Flange portion

92a: Inner resin continuous portion (continuous portion)

92a1: First continuous portion (first portion)

92a2: Second continuous portion (second portion, first second portion)

92a3: Third continuous portion (second portion, second second portion)

92a4: Fourth continuous portion (second portion, second second portion)

271: Coupling portion

272: Opening portion

C: One set of heat absorbing members

CL: Center axis

L1a: First inner resin layer (first resin layer)

L1c: First metal layer

L2a: Second inner resin layer (second resin layer)

L2c: Second metal layer

S1: First side

S2: Second side

S3: Third side

S4: Fourth side

It should be understood that various changes and modifications to the embodiments described herein will be apparent to those skilled in the art. Such changes and modifications can be made without departing from the spirit and scope of the present subject matter and without diminishing its intended advantages. It is therefore

intended that such changes and modifications be covered by the appended claims.

1. A battery pack comprising:
a plurality of secondary batteries each having a cylindrical shape; and
a heat absorbing member that has a heat absorbing agent and an exterior body accommodating the heat absorbing agent, wherein
the exterior body includes
a first exterior portion that has a first resin layer and a first metal layer overlapping with the first resin layer, and
a second exterior portion that has a second resin layer facing the first resin layer and a second metal layer overlapping with the second resin layer,
the exterior body integrally includes
an accommodating portion that accommodates the heat absorbing agent between the first resin layer and the second resin layer, and
a flange portion in which the first resin layer and the second resin layer overlap with each other over an entire circumference of the accommodating portion,
the flange portion has a continuous portion in which the first resin layer and the second resin layer are continuous over an entire circumference around the accommodating portion,
the continuous portion includes a first portion and a second portion,
the first portion is located inward of at least one of the first metal layer or the second metal layer in a sectional shape of the heat absorbing member when cut along a plane along a thickness direction of the flange portion,
the second portion has a portion exposed to outside of the exterior body in the sectional shape of the heat absorbing member when cut along the plane along the thickness direction of the flange portion, and
the heat absorbing member is arranged in an orientation in which the first portion is closer to an end of each of the secondary batteries than the second portion in an axial direction in which a center axis of each of the secondary batteries extends.

2. The battery pack according to claim 1, wherein
two heat absorbing members identical to the heat absorbing member are provided, and
the two heat absorbing members are arranged along the axial direction and spaced apart from each other.

3. The battery pack according to claim 1, wherein
a space between the two heat absorbing members is located in a central portion of each of the secondary batteries in the axial direction.

4. The battery pack according to claim 1, further comprising:
one set of heat absorbing members that integrally includes the two heat absorbing members and a coupling portion that couples portions on the second portion side of the flange portions in the two heat absorbing members to each other, wherein
the one set of heat absorbing members includes an opening portion between the portions on the second portion side of the flange portions in the two heat absorbing members.

5. The battery pack according to claim 4, wherein
the opening portion is located in a central portion of each of the secondary batteries in the axial direction.

6. The battery pack according to claim 1, wherein
the second portion includes
a first second portion that is a portion on a side opposite to the first portion in the axial direction, and
a second second portion that is closer to an end of each of the secondary batteries than the first second portion, and
when the heat absorbing member is viewed along a direction orthogonal to the axial direction, a distance along the axial direction between an inner peripheral edge of the first second portion and an outer peripheral edge of a portion exposed to outside of the first second portion is shorter than a distance along a direction orthogonal to the axial direction between an inner peripheral edge of the second second portion and an outer peripheral edge of a portion exposed to outside of the second second portion.
